(19) United States
(12) Patent Application Publication
(10) Pub. No.: US 2004/0199491 A1
(43) Pub. Date: Oct. 7, 2004

(54) Domain specific search engine

(76) Inventor: Nikhil Bhatt, Cupertino, CA (US)

Correspondence Address: THE HECKER LAW GROUP, 1925 CENTURY PARK EAST, SUITE 2300, LOS ANGELES, CA, 90067, US

(21) Appl. No.: 10/461,642

(22) Filed: Jun. 13, 2003

Related U.S. Application Data
(63) Continuation-in-part of application No. 10/407,853, filed on Apr. 4, 2003.

(51) Int. Cl. G06F 17/30

(52) U.S. Cl. 707/2

(57) ABSTRACT

The invention described herein is directed to a search engine configured to locate data within a defined domain. The user may input keywords and graphically select one or more attributes for conducting a search. The system then utilizes the keywords and other attributes and classification terms to define one or more search domains (e.g., dimensions). The keywords are tightly associated with an index that represents data within the search domain. For instance, one embodiment of the invention utilizes metadata to build an index that associates a set of files (e.g., audio files) with a number of distinct classifications expressed in the form of the exposed set of keywords. To this end, the method involves a mechanism for defining and collecting metadata.

### CONTINUITY

This application is a Continuation-in-Part and claims the benefit of U.S. patent application Ser. No. 10/407,853 filed Apr. 4, 2003.

### FIELD OF THE INVENTION

The invention described herein relates to the field of computer software and more specifically to a search engine configured to execute domain specific searches.

### BACKGROUND OF THE INVENTION

It is possible using current software programs for users to create songs and/or music tracks by combining pre-recorded audio data (e.g., ACID™ distributed by Sound Foundry™, Incorporated). Typically, the user starts to compose a music track by selecting a set of music files from a data bank of music files. Users can obtain music files from large libraries, either from freely available repositories or as a purchased product (e.g., CDs, etc . . . ). Most project creators (e.g., users) have archives containing a significant number of music files and other audio files. One type of commonly used audio file is referred to as a loop. These loop files and other audio files are typically stored in set of directories where each directory defines the type of data within that directory. Loops that relate to “acoustic bass”, for instance, might be stored in a directory titled “Bass”. Some projects may utilize several gigabytes of loops on a disk spread over several directories with similar or dissimilar names. When users are looking for data, it is challenging to find a desired loop (e.g., guitar) because the users are often forced to listen to possibly hundreds of irrelevant loops just to locate one loop.

Existing applications allow the user to browse a file hierarchy and preview sounds. However, browsing for files in this fashion is practical only when there is a limited set of audio files to examine. For example, to locate an acoustic bass track, a user might browse through a directory that contains a limited number of bass tracks (e.g., a directory that has a file named “acoustic bass”). However, users typically purchase libraries of loop files on CD or some other data storage medium. These libraries are typically organized into a set of directories and sub-directories, which help to reduce the number of files worth previewing. As an example, the loop files may be stored in a set of sub-directories organized by instruments, (e.g., turntables, piano, flutes, etc), which in turn may have other sub-directories bearing self-describing names. The sheer number of files the user may have to preview makes the task of selecting a music loop a daunting one. A user may spend a considerable amount of time browsing a CD to locate a particular sound. Furthermore multiple CDs of loops may be available to the music creator, and if, as a simple example, every single CD is organized in the same fashion described above, then there would be multiple directories containing the same basic instrument that a user would have to traverse. A user looking for guitars, for example, may have loop directories CD-1/guitars/electric/etc, CD-2/guitars . . . and CD-N/guitars. The user is required to review the contents of each CD to find the desired loop. To minimize the necessity to perform the manual search process discussed above, some systems utilize software programs configured to locate the data the user desires. These software programs (termed search engines) refer to any computer system configured to locate data in response to a query for that data. Search engines may, for instance, provide users with a mechanism for retrieving data stored in places such as the World-Wide-Web (WWW), storage devices such as Compact Discs (CD), hard drives, or data stored on any other type of data storage location. To use the functionality of a search engine, users are typically required to formulate the query that defines the scope of the search to be performed by the search engine. Once the query is submitted the search engine traverses an index based on information collected from the data itself. In the case of web pages, the text contained in web pages may serve as an index for the web page from which it comes. The user's query may then simply consist of one or more keywords (or a combination thereof), which defines the search scope. Existing search technologies are weak when used to locate audio files. Audio files do not contain a sufficient set of natural language based data to enable textual indexing and searching. Moreover, classifying a set of audio files involves a level of subjective analysis that is best performed by human beings. With existing techniques this subjective aspect of classification often results in the entry of overly broad queries. When such overly broad queries are made the set of results the search engine returns may be too large and therefore of little use to the user. For example, when a search engine is used to find audio data (e.g., AIFF, WAV, MP3, etc . . . ) users enter a query that defines the type of audio files the user is attempting to locate. For instance, if a user were trying to locate an audio file that contained a Jamaican drum beat, the user might build a query that looks for the words “Jamaica” and “drums.”

Prior art search engines utilize this query information to search for these keywords. If the file containing the data that the user is attempting to locate bears the name “track0001.wav”, the system would be unable to locate the file based on the information provided by the user. If the file is stored in a directory that bears the name “c:\MyMusic\Jamaica” the system may have the ability to locate all of the files stored in that directory, but could not limit the results to drum music only. If the user inputs a more general query (e.g., *.wav”, the system can locate the “track0001.wav file, but will also locate every other WAV file on the system. To create a query that returns the audio data the user is looking for, users must have specific knowledge as to how files on the system are named and what directory organization is used. However, in the large majority of cases users do not have such specific knowledge and are therefore left to manually browse through and listen to various audio files to locate the desired file.

Other disadvantages associated with existing search engine technologies include the lack of any correlation between different attributes of a single file. For example, a guitar may be recorded in such a manner that it was “intense”, “distorted”, and “processed”. For the file to found by a traditional search engine, the user would be required to place the file in three different locations (one for each attribute). If the file were only placed in one of the three locations (in order to conserve space), then queries for the other two attributes would fail. As the number of attributes rise into the dozens, copying the files continually is both space-inefficient and error-prone.

Therefore, there is a need for a search engine that enables users to search a specific domain (e.g., type of file) to quickly locate data within the search domain. This would save users the time and hassle associated with the prior art techniques discussed above.

### BRIEF DESCRIPTION OF DRAWINGS

FIG. 1 is a block diagram that depicts the various processes implemented by one or more embodiments of the invention.

FIG. 2 illustrates a method for building an index from metadata in accordance with an embodiment of the invention.

FIG. 3 is a flowchart illustrating the process for indexing a directory of files in accordance with an embodiment of the invention.

FIG. 4 is an example of a user interface for assigning tags and descriptors to a sound file.

FIG. 5 is an example of a user interface for assigning a musical key property tag to a sound file.

FIG. 6 is an example of a user interface for performing selection and assignment of a scale type to a musical key property tag of a sound file.

FIG. 7 is an example of a user interface for performing selection and assignment of time signature to a sound file.

FIG. 8 is an example of a user interface for associating metadata (e.g., property tags) with a sound file.

FIG. 9 is an example of a user interface for associating a musical genre with a sound file.

FIG. 10 is an example of a user interface for associating instrumentation category tags with a sound file.

FIG. 11 is an example of a user interface for assigning and selecting descriptors for a sound file.

FIG. 12 is an example of a user interface for indexing audio files.

FIG. 13 is an example search engine interface in accordance with an embodiment of the present invention.

FIG. 14 is an example of a button view search engine interface in accordance with an embodiment of the present invention.

FIG. 15 is a flowchart that illustrates the overall steps involved in the process of searching an index to find files that match one or more sets of search criteria in accordance with embodiments of the invention.

FIG. 16A is a flowchart that illustrates steps involved in searching an index using keywords in accordance with embodiments of the invention.

FIG. 16B is a flowchart that illustrates the application of further search constraints on a set of keyword search result in accordance with embodiments of the invention.

FIG. 16C is a flowchart that illustrates steps involved in organizing the output of search result in accordance with embodiments of the invention.

### SUMMARY OF INVENTION

The invention described herein is directed to a search engine configured to locate data within a defined domain. The user may input keywords and graphically select one or more attributes for conducting a search. The system then utilizes the keywords and other attributes and classification terms to define one or more search domains (e.g., dimensions).

The search engine may, for example, operate within the audio domain and thereby provide users with an effective mechanism for locating digital audio files. Although the invention has many uses it is particularly helpful in instances where the task at hand requires users to review a number of files before ultimately making a selection. The domain specific search engine can, for example, help users quickly find data for purposes of making such a selection by utilizing a search algorithm that accepts as input a set of keywords exposed to the user via a graphical user interface. These keywords are tightly associated with an index that represents data within the search domain. For instance, one embodiment of the invention utilizes metadata to build an index that associates a set of files (e.g., audio files) with a number of distinct classifications expressed in the form of the exposed set of keywords. To this end, the method involves a mechanism for defining and collecting metadata.

The term metadata as used herein refers to any data descriptive of the data file it defines. For example, information identifying that a particular data file has a certain set of characteristics and/or belongs to a particular set of classifications may qualify as metadata. In one embodiment of the invention metadata is defined by the user (e.g., using specific keywords for describing categories and classification nomenclatures) and appended to or associated with the data file the metadata defines. It is also feasible for the system to obtain metadata or other data by other means. In the audio domain, for example, the key or time signature of a music loop may be part of the metadata description associated with music data files. The metadata description may also contain subjective characteristics or user defined descriptions that in some way described the data to which the metadata is related. To define what qualifies as metadata, an embodiment of the invention utilizes a tool that is tightly coupled with the index. This tool enables users to associate metadata with a file in a way that corresponds with the set of classifications stored within the index. In at least one instance, the tool is a graphical interface for viewing and defining the metadata, attributes, or other characteristics associated with a data file.

In instances where metadata is not predefined, the system may collect data and then utilize that collected data as metadata for purposes of generating an index by applying a collected data set against a set of heuristic information (e.g., classification information) stored and managed by a translation engine. When operating within a specific domain, any information that identifies definable aspects of a file qualifies as collected data. The system can, for example, collect metadata from a file name, directory structure, or other sources related to a particular file and then apply that information against a translation document for purposes of building an index. Thus the system may extract information from sources that describe the data files. For example, the system may extract music classification information from a self-describing nomenclature for naming files and directories in a hierarchical directory structure. The system is also enabled to build a list of descriptive keywords by mapping collected words and phrases to an esoteric list of classification keywords.

Once the index is built that index is loaded into memory and made accessible for users to initiate queries against using a constrained set of keywords. When queried, the search engine executes a search algorithm that compares the keyword to the index and returns a reduced set of results associated with the keywords the user is attempting to locate.

### DETAILED DESCRIPTION OF THE INVENTION

Embodiments of the invention comprise a method and apparatus for implementing and performing a domain specific search. In the following description, numerous specific details are set forth to provide a more thorough description of the present invention. It will be apparent, however, to one skilled in the art, that the present invention may be practiced without these specific details. In other instances, well known features have not been described in detail so as not to obscure the present invention. The claims, however, and the full scope of any equivalents are what define the metes and bounds of the invention.

Introduction

The invention described herein is directed to a search engine configured to locate data within a defined domain. This search engine may, for example, operate within the audio domain and thereby provide users with an effective mechanism for locating digital audio files. Although the invention has many uses it is particularly helpful in instances where the task at hand requires users to review a number of files before ultimately making a selection. The domain specific search engine is configured to help users quickly find data for purposes of making such a selection by utilizing a search algorithm that accepts as input a constrained set of keywords exposed to the user via a graphical user interface. These keywords are tightly associated with an index that represents data within the search domain.

For purposes of clarity a brief discussion of some of the terminology used throughout this description follows. A more detailed description of various embodiments of the invention begins in the section below titled “Overview of the Invention.”

Terminology

The term “metadata” refers to a set of descriptive data associated with one or more files of data. For example, if an audio file contains sound data for music or speech, the associated metadata may contain a date of recording, a topic of a speech, music genre and any type of descriptive data that enables a system or a human to describe, classify and characterize the audio file.

It is possible to represent metadata using many different formats. For example, the extensible markup language (XML) file format may represent the metadata or any other information associated with the file. XML is a standard that enables users to represent data structures using user-defined tags and although XML is used herein for purposes of example, the terms “tag” and “metatag” are not limited specifically to such an implementation. Thus, the terms “tag” and “metatag” may refer to more than user defined data fields. These tags may, for instance, contain any type of descriptive information. Systems embodying one or more aspects of the invention may parse, search, convert and exchange this descriptive information within one computer application or across multiple applications. In some instances, for example, a tag may contain information that refers to specific attributes or functionalities in an application. For example, a specific tag may hold a uniform resource locator (URL) that indicates the location of the most up-to-date metadata. Embodiments of the invention may store metadata as part of a data file, in separate files, as one or more records of one or more database tables in a relational database, on a network storage location that streams the data, or using any other data storage means.

The search engine described herein is adapted in at least one instance to locate audio files, but the concepts and ideas conveyed in this document are applicable to locating other types of data files. For example, it is feasible to implement the domain specific search engine to handle images, video clips, interactive maps, medical imaging data or any other type of data. Thus, readers should note that the following description uses audio files for purposes of example only. It will be apparent to those of ordinary skill in the art that the methods of this invention are applicable for handling other types of data.

Throughout the following disclosure, usage of the term “user” may refer to a person using a computer application (e.g., end user or developer) and/or to one or more automatic processes. The automatic processes comprise computer programs executing locally or on a remote computer, and may be triggered to communicate with embodiments of the invention following one or more types of events. Thus, readers should be aware that in some instance, the term “user” interchangeably refers to an end user, a developer, or the system itself.

Overview of the Invention

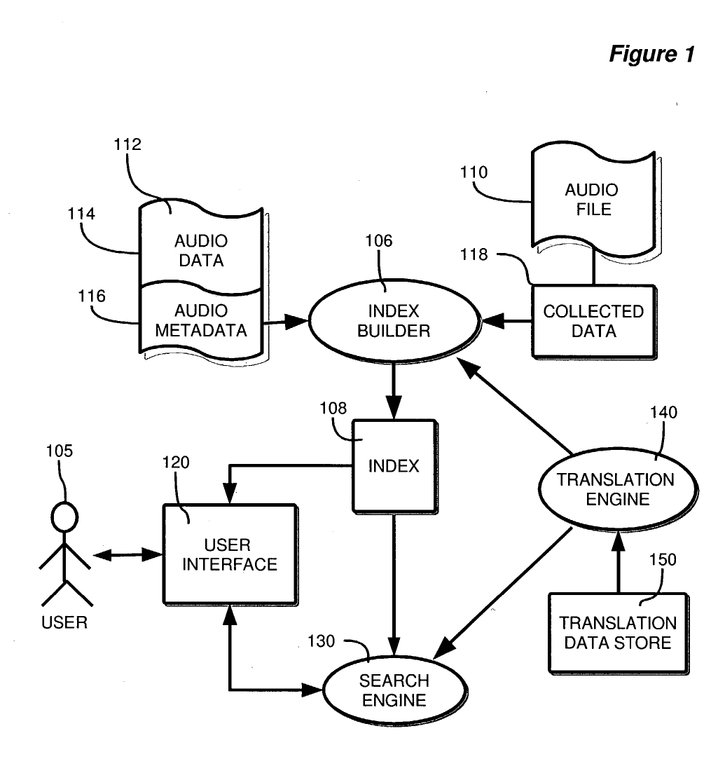

FIG. 1 is a block diagram that depicts the various processes implemented by one or more embodiments of the invention. A user 105 interacts with a system embodying one or more aspects of the invention through a user interface 120 (see below for further details on the layout and functionality of the graphical user interface). The user interface 120 allows the user 105 to view, access, edit and input metadata through the use of graphical widgets such as radio buttons, check buttons, pull-down menu, text fields and any other graphical widget available through a computer graphical interface. The metadata provided through the user interface is either loaded from a source 112 that typically comprises metadata 116 (e.g. an XML file) appended to an existing data file 114, or from data collected 118 by a system embodying the invention. In at least one instance, the invention is capable of collecting various types of information. For example, when loading a data file 110 that is not associated with any specific set of metadata the system may collect data from other available sources (e.g., a directory path, filename, etc . . . ).

The system contains an index-building module 106 capable of accessing any type of metadata and/or collecting data, and using that data to build an index. The index contains many types of information about data files. The index-building module utilizes the functionality of a translation engine 140, which allows the module to build the index using a standard set of keywords. Those keywords serve as the basis for representing the data attributes on the user interface, and provide fast search functionality through a large volume of data files.

The user interface 120 utilizes a translation engine 140 and an associated translation data store 150. The translation engine 140 enables a system embodying the invention to provide several translation tasks: for example, the translation engine can optionally enable the system to display information in any language while using a common internal representation of the data. A specific instance in the latter example is concerned with internationally recognized music categories bearing different appellations that depend on the locales.

Another aspect of the invention where the translation engine plays a critical role is concerned with the search process. Searching sometimes requires mapping an unusual word (or a phrase) to a more commonly used word/phrase. The translation engine utilizes a translation data store 150 that holds one or more mappings between words (and phrases). Thus the translation data store 150 may contain a collection of keywords (and key phrases) utilized to efficiently describe audio content in a manner that corresponds to the type of music (or data files) made available by the search engine. Furthermore, the translation data store 150 may contain a dictionary of descriptives built on the semantics of the keywords and key phrases, using a heuristics approach. Therefore, a subset of descriptive keywords and key phrases may be utilized as a basis set of descriptive keywords and key phrases to which other less commonly used keywords and key phrases in the whole set are mapped. For convenience, the description refers to “master list” as the subset of keywords and key phrases in a basis set. The translation engine 140 and translation data store 150 are, therefore, used not only as a trans-language translator, but also as an intra-language mapping tool.

Embodiments of the invention enable a user 105 to search for audio files 3 that have specific characteristics. The user 105 may effectuate a search for one 4 or more types of data, by selecting keywords from the proper graphical widgets. The search may be further refined by entry of a keyword or key phrase. In its simplest implementation, the search engine matches the user input with an index of metadata originating from a bank of files that already possess an associated metadata portion. However, the system may detect whether an audio file already contains metadata that allows the system to index the audio file using keywords/key phrases. The system collects data about a file using user data provided in a separate data source (e.g. flat file or a relational database) to build a list or keywords/key phrases. The search engine 130 may then utilize the translation engine 140 to map the list of collected keywords and key phrases to a list of keywords and key phrases from the master list.

When the invention is applied to software programs configured to assist users with the process of creating music (e.g., by using a set of pre-recorded audio files), the system is adapted to allow the user to enter music specific queries. These music specific queries comprise a constrained set of keywords tightly coupled with the audio data the user is attempting to locate. Users can, for example, enter or select (by checking a graphical widget placed next to a keyword or a key phrase) known keywords to search for specific audio files.

The search engine 130 is designed to locate any type of audio file, but in at least one embodiment is configured to locate loop files. Loop files contain music segments that seamlessly merge at the beginning and end of the file so that during playback it is feasible to repeat the file numerous times without hitting an endpoint. Embodiments of the invention implement a mechanism for enabling users to locate loop files and other audio files without using the name of the file itself or requiring manual playback of the file. The invention enables such users to locate data that matches specific criteria without requiring the user to engage in an extensive trial and error process to determine a set of appropriate keywords as used in prior art systems. For example, when using prior art techniques users looking for a loop file that contains rhythmic guitar music would have to listen to many different guitar loops to locate the rhythmic loop for their application. When using a system implementing one or more embodiments of the invention, users looking for rhythmic guitar loops of a certain note are able to narrow the search results to only rhythmic guitar loops, and further define the search to contain only loops within one to two notes (or any other threshold level) of the desired note.

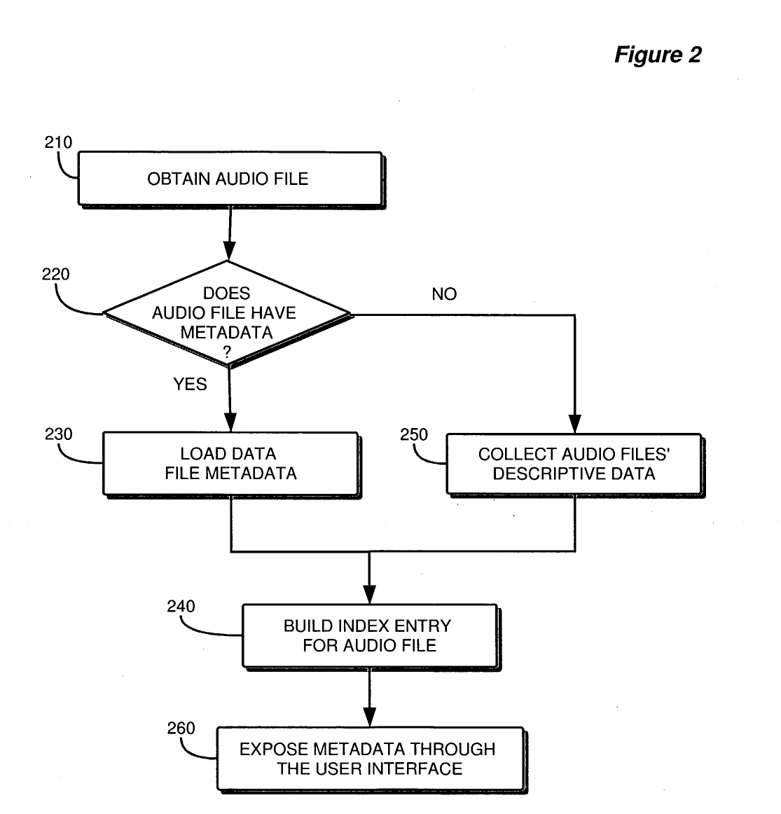

FIG. 2 illustrates a method for viewing metadata in accordance with an embodiment of the invention. At step 210, the system obtains file information that comprises file location information (e.g. directory path). At step 220, the system investigates the file (or files) relating to the metadata to be viewed. At step 230, the system checks whether the file has metadata data. Typically, the system obtains metadata via a process that involves a user manually defining the attributes or characteristics of a file. The system may also collect data automatically. The metadata is then stored in an easily accessible location. For instance, in one embodiment of the invention such metadata is incorporated within the file to which the metadata relates. Metadata may, for instance, be appended to the audio file (see “file enhancement” below for detail). In other instances, metadata is stored in a data source that is independent from the file to which the data relates.

When a system determines the metadata is already available, it loads the data directly from the file at step 230. Loading the metadata involves, for instance, parsing XML data and creating representations of user and/or application defined tags. At step 240, the system utilizes the metadata keywords to build an index. The index allows the graphical user interface to display information about the data, and users to conduct file searches in an efficient manner using the graphical widgets of the user interface.

When an audio file does not provide associated metadata, the system proceeds to collect data about the audio file (e.g., at step 250). The system may collect data from multiple sources. For example, when a bank of audio files is available on a storage medium such as a Compact Disc (CD), the file directory structure on the CD may possess a hierarchical structure that refers to a widely used classification system. For instance, the hierarchical structure of the CD may classify music according to a music genre, author, record label and any other category information. Using the translation engine, a system embodying the invention is capable of mapping the collected information to keywords and key phrases that are part of the master set used to graphically display information to the user. At step 260, the system generates whatever graphical components are necessary to display audio file information.

Indexing Data Files

The process of indexing audio files having associated metadata involves collecting and collating the tag information associated with each of the audio files in order to make a usable index for the search engine. The information collected during the file enhancement process discussed above is what defines the tags associated with each audio file being indexed. Since prior art audio files have no tag information, there are two aspects to indexing.

The first aspect involves those audio files that do not have tag information, as is the case in audio files formatted with current audio file formats (e.g., WAV, AIFF, etc . . . ). In these cases, tagging may be provided either for a single file or for multiple files in a batch mode using the methods described above. For instance, batch mode tagging may be desirable if most or all of the files being tagged have common characteristics, e.g., acoustic guitar. Additional tagging for individual files may be subsequently applied after batch mode tagging to highlight the specific characteristics of each individual file. And as discussed above, these tags maintain the audio integrity of the audio file while simultaneously providing helpful data to the search engine. Thus, in one embodiment of the invention, tagged files are compatible with prior art systems, but are able to provide the search engine with detailed information about the contents of the audio file.

The second aspect of indexing involves collecting and collating tag information from audio file files in a directory. The indexer (also referred to as an index building module) carries out the indexing in one or more phases depending on the availability of information.

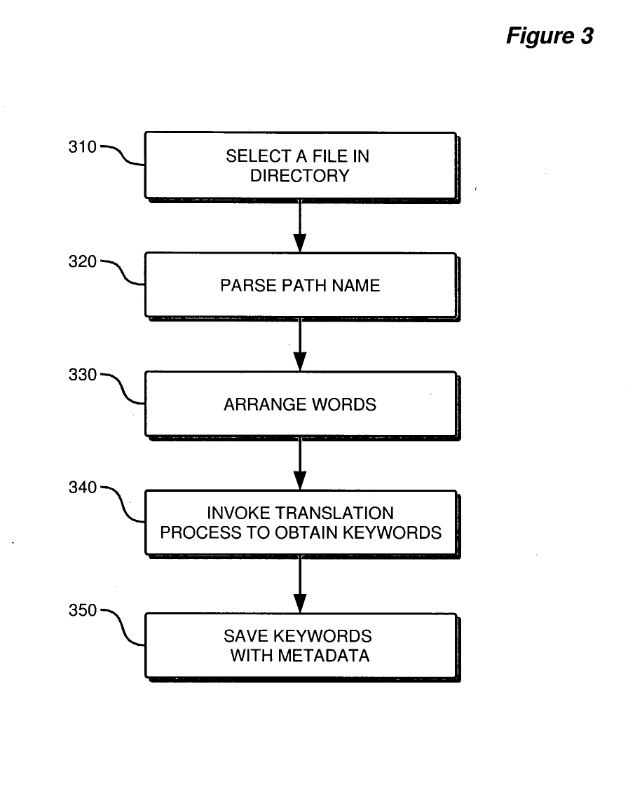

To index a directory, the system embodying the invention attempts to obtain keywords or infer keywords from the tag information provided for each file in the directory. FIG. 3 is a flowchart illustrating the process for indexing a directory of files in accordance with an embodiment of the invention. Indexing in the manner depicted in FIG. 3 is appropriate when a file lacks an existing set of metadata and is part of a file directory structure having an explicit self-describing nomenclature. To index a directory, the user selects a directory to be indexed. At step 310, the system selects a file to be processed. At step 320, the system parses the file path name. During path decomposition, the indexer parses each file path name to obtain the user provided information used to populate the tags. At step 330, the system arranges the collected information into individual words and/or various pairs of words, e.g., “rhythm guitar”, or “hip hop”. At step 340 the individual words and pairs of words are processed through a translation process, e.g., table lookup, to generate search keywords. The keywords that are not found in the translation table may be inferred using past knowledge, for example. These search keywords are then saved at step 350.

While processing each directory during indexing, the indexer parses the audio files and generates words and pairs of words. Because the indexer may not have access to the source of the tags, it may need to translate the words and pairs of words using known information. The indexer is capable of inferring the keywords using past knowledge. In one embodiment, the indexer runs this list of possible keywords and word pairs through a translation dictionary that contains an extensive list of data. Thus, the translation dictionary contains a set of mappings to the tagged keywords defined via the file enhancement process discussed herein. An expert user defines the translation table so that the table represents an accumulation of likely search terms and correlates these terms to the tagged keywords. In some instances certain aspects of the translation table are optionally encrypted for purposes of security. The following XML listing illustrates an example set of translation table entries:

Sample Translation Table

<key>Flutes</key><string>Flute</string>
<key>Gnarled</key><string>Dark</string>
<key>Drum Machines</key><string>Electronic Beats</string>
<key>Deep Atmospherics</key><array><string>Cinematic/New
Age</string><string>Texture/Atmosphere</string><string>
Processed</string></array>

In this example, the words or word pairs generated by the indexer from the tags are bracketed as follows: <key> words or word pairs </key> and the resulting keywords and keyword pairs are bracketed as follows: <string> keyword or keyword pairs </string>. Thus, the entries in the sample translation table above indicate that words like “Flutes” will translate into “Flute” and “Gnarled” will translate into “Dark”. Word pairs like “Drum Machines” will translate into “Electronic Beats”, and “Deep Atmospherics” will translate into multiple keywords such as “Cinematic/New Age”, “Texture/Atmosphere”, and “Processed”. Readers should note that the translation table shown here is for exemplary purposes only and not limited in any of the specific set of mappings described. At a conceptual level, the translation table simply represents any set of terms mapped to an exposed set of keywords. For instance, the translation engine may map a single word like “chorus” to “ensemble”. Thus, the benefit of translation is that numerous simple words, e.g., “chorus”, obtained from the audio file directories may be mapped to a smaller set (or master list) of keywords which is much more manageable during the search process.

This process may be referred to as “Search key translation” because it translates information provided in the audio files to appropriate and manageable search keys. One advantage of search key translation is that the tag information in an audio file may be in any language. And irrespective of language, the proper search results may still be obtained since the translation dictionary should contain all the possible keywords in all the languages. Thus, the translation phase involves associating tag information to a limited set of search keywords. For an example of search key translation of the word pairs, assume the tag information is such that the word pair is “Spanish guitar”. The translation engine may assign multiple keywords to a single word pair so that, for example, “Spanish guitar” may be assigned to “acoustic guitar” and “world/ethnic”. And the translation engine will do this for every single word and pair of words as it tries its best to infer the proper keyword from the provided tag information. The translation engine may also associate various interpretations with the word pair so that entries in one language map to another. The word pair “Guitarra Espanol” may, for instance may to “Spanish guitar” which in turn is associated with an appropriate set of keywords.

Thus, the indexing phase of an embodiment of the invention provides a mechanism for attempting to generate appropriate search keywords using the translation engine. The indexer takes a very large set of words and distills it down to a very compact set of words thereby allowing the user to do a search from a user interface that gives a precise set of matches. This is unlike prior art search engines where each word stands by itself with the exception of “a” and “the”.

The translation engine may also contain a diagnostic mode. The diagnostic mode may dump the words and pairs of words that could not be processed so that the information may be included in the translation database (or table). Thus the translation table is capable of learning as things change.

Searching Data Files

An embodiment of the invention allows the user to see what is available and provides the necessary keywords to obtain the correct results when searching for a desired type of audio file. For instance, assume a user is searching a CD having 11,000 files, for audio files using a particular type of guitar. Also assume that 850 of the audio files on the CD use the type of guitar the user is attempting to locate. The user can simply enter “guitar” and the search engine will compare the input against 11,000 audio files and return for 850 audio files.

This and other searching functions are accomplished in one embodiment of the invention by utilizing a tagging technique to build the metadata that associates a set of audio files with a number of musically distinct classifications. When queried, a search engine utilizes the index built using the metadata to locate audio files that fall within the parameters of the query. A query-building tool that is tightly coupled with the index is presented to the user via a Graphical User Interface. In contrast to prior art search engines that hide the index, embodiments of the invention make a portion of the index available to the user as part of the query-building tool. The query-building tool constrains user inputs to match the classifications stored within the index. By effectively managing the inputs, the search engine described herein is able to return a better set of results than existing search engines. For instance, the search engine described herein is capable of locating a set of useful files by providing the user access to the keywords that are specific to the search query thus controlling the results of the search operation.

The index is built in accordance with one embodiment of the invention from information embedded into or associated with a set of audio files. Audio file formats such as WAV or AIF formats do not have an appropriate way to index the contents of a file. One aspect of the present invention provides users with a mechanism for tagging a set of audio files such as WAV or AIF files to embed information into the file the search engine may later use for purposes of locating the tagged file. This tagging process is referred to in one embodiment of the invention as file enhancement. Once a file is appropriately tagged the search engine uses the tags for later indexing.

File Enhancement

The process of file enhancement involves assigning specific identifying information in the form of tags to a file (e.g., an audio file). For instance, users may identify the content of an audio file and thereby classify the audio file into one or more categories (e.g., property tags, category tags, and descriptors). In one embodiment of the invention, property tags define the musical properties of the audio file. Category tags, for example, provide a set of keywords that a user might use when searching for a particular type of music, and descriptors may provide information about what type of mood an audio file conveys to the audience, for example, cheerful. One or more of these tags correspond to the underlying metadata.

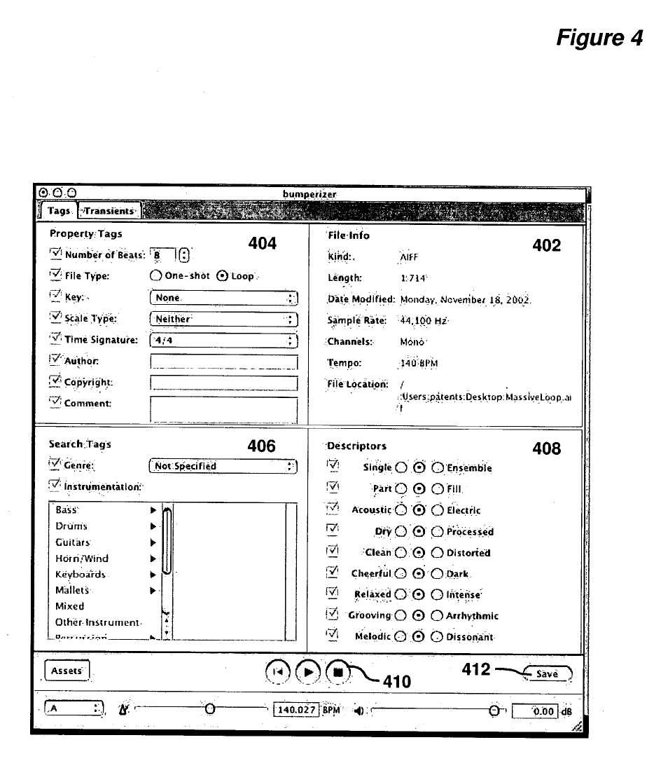

FIG. 4 is a sample user interface for assigning tags and descriptors to a loop. In one embodiment of the invention data written in the eXtensible Markup Language (XML) is what defines the tag information. Those of skill in the art will recognize that the term tag refers to any type of information about an audio file and that the term is not limited only to the examples given herein. Moreover readers should note that although the tagging of audio files is performed here via a Graphical User Interface, the invention contemplates tagging files manually, via a command line process, or using any other technique acceptable for purposes of associating the tag data with the audio file.

In this sample illustration, basic information about the file to be tagged is provided in block 402. Block 404 contains a list of sample property tags that describe the number of beats, whether the audio file is a loop or a one-shot, the musical key, the scale type, the time signature, etc.

Block 406 contains sample category tags. For example, category tags may include musical genre and instrumentation. The instrumentation category may include bass, drums, guitars, horn/wind, keyboards, mallets, mixed, or any other type of instrument.

In block 408, descriptors may be assigned to the file. For instance, the audio file could have originated from a single player (i.e. soloist) or an ensemble, be part or fill, acoustic or electric, dry or processed, clear or distorted, cheerful or dark, relaxed or intense, grooving or arrhythmic, melodic or dissonant, etc.

In this illustration, controls 410 allow playback of the file while tagging. This capability enables users to tag a file while the sound and other general characteristics of the audio file are still fresh in the users mind. After tagging the audio file button 412 writes the file to disk for later use.

In one embodiment of the invention, the tag information is appended to the end of the audio file without distorting the content of the audio file. By appending the tag information at the end of the audio file, the system may still read and play the tagged audio file. Thus, the tagging process does not affect playback of the file itself. Media players and other audio playback applications are still able to recognize and play the tagged file. Other embodiments of the invention append tag information in other portions of the audio file such as the header, beginning, etc. It is also feasible to store the tag information in a separate file where that separate file is associated with the audio file via an appended pointer or some other means.

Property Tags

Audio files may contain embedded property information such as speed counts and basic type information. Although such information provides some basic characteristics about the audio file, this information is not sufficient for purposes of searching.

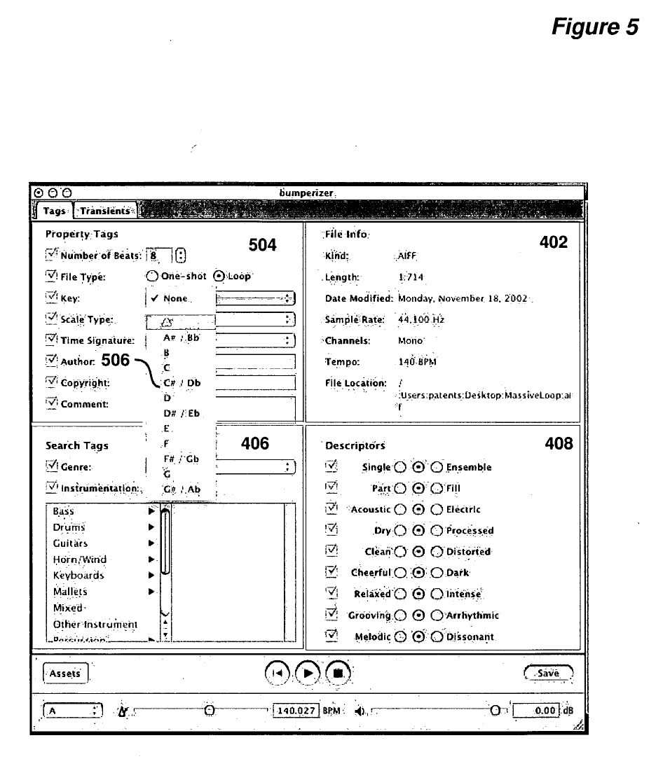

FIG. 5 illustrates an assignment of a property tag that defines the musical key of the audio file: massiveloop.aif (see block 402). The interface allows users to assign the appropriate key from a drop down menu 506 for selection from all the musical keys, e.g., A, A♯/Bb, B, C, C♯/Db, D, D♯/Eb, E, F, F♯/Gb, G, and G♯/Ab.

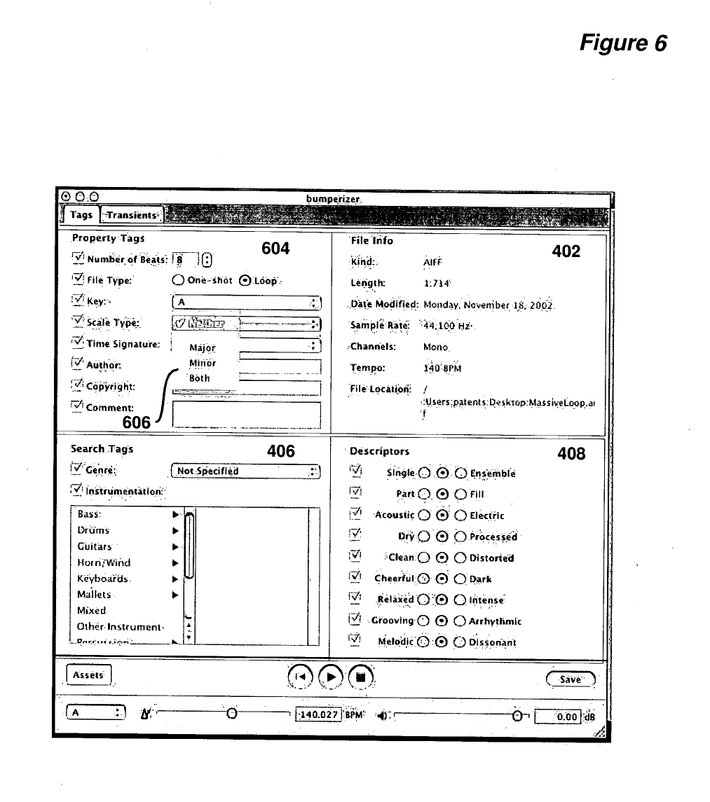

FIG. 6 illustrates an assignment of scale type to the musical key. For instance, drop down menu 606 in property tags selection block 604 allows assignment of major, minor, both major and minor, or neither major nor minor to the musical key.

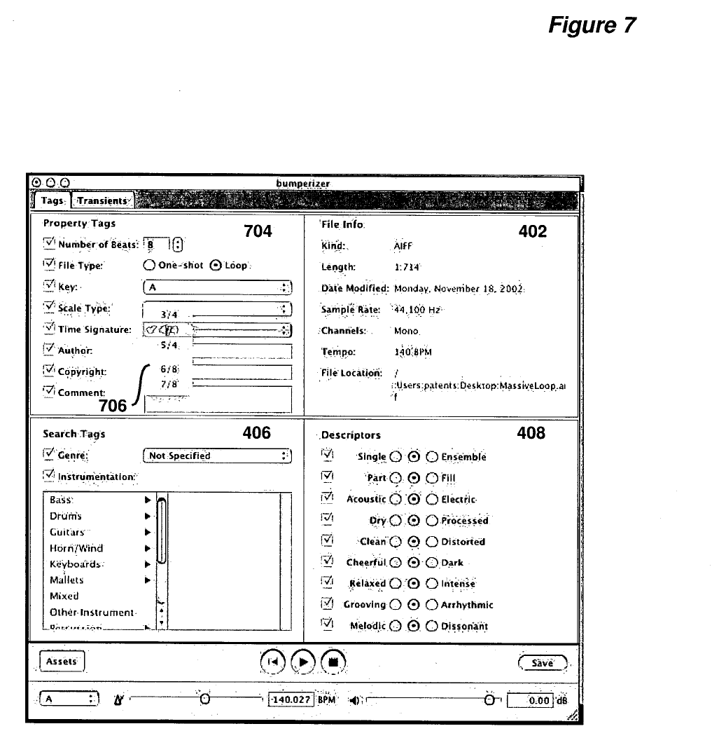

FIG. 7 illustrates the selection and assignment of time signatures to a sound file. Drop down menu 706 in property tags selection block 704 allows assignment of any one of time signatures 3/4, 4/4, 5/4, 6/8, 7/8, or any other reasonable time signature. The time signature is a description of the beats of the music. The numerator represents the number of beats; the denominator, the length of each beat. For example, a designation of 3/4 means that the audio file has three quarter notes per measure; 6/8 denotes six-eight notes per measure; and 4/4 denotes four quarter notes per measure. 4/4 is the most common time signature.

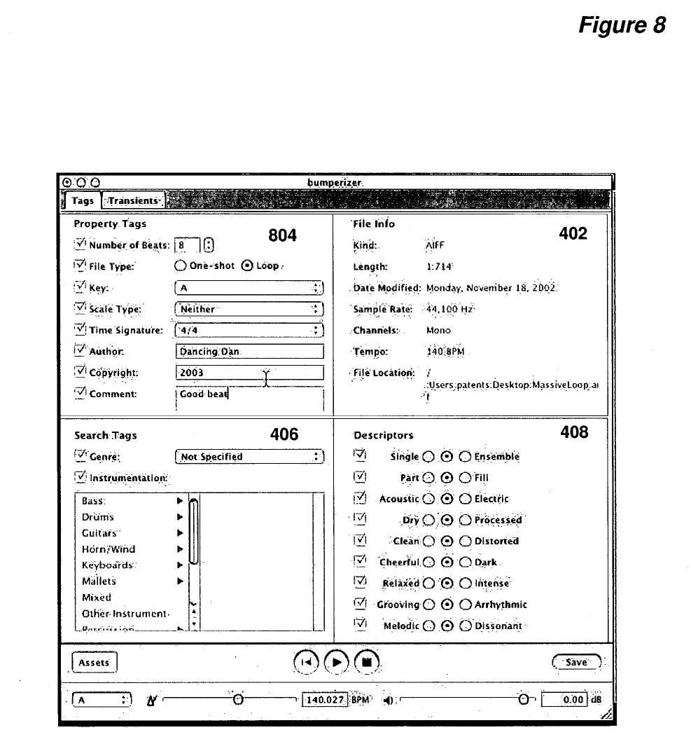

The remainder of the property tag fields, e.g., author, copyright, and comment are editorial and may be completed as shown in FIG. 8, block 804. FIG. 8 illustrates a complete set of the assignable property tags. For instance, block 804 shows that the following properties have been assigned to the file massiveloop.aif: number of beats is “8”; audio file type is “loop” instead of “one-shot”; key is “A”; scale type is “neither” major nor minor; time signature is “4/4”; author is “Dancing Dan”; copyright is “2003”; and comment is “Good beat”.

Category Tags

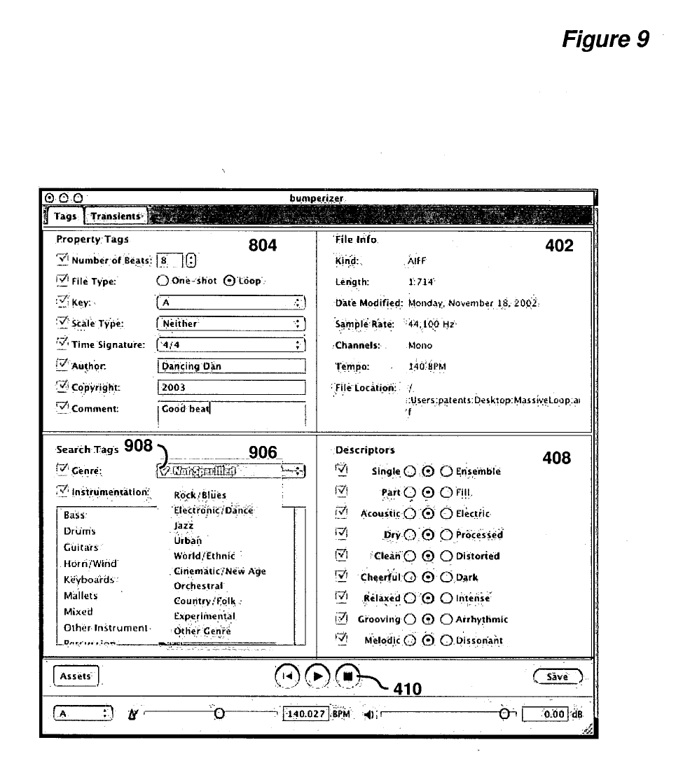

As discussed earlier, the assignment of keywords for purpose of enabling the search engine to return a narrow result is an important aspect of the invention. One embodiment of the invention utilizes a tagging technique to build an index that associates a set of audio files with a number of musically distinct classifications. FIG. 9 illustrates the assignment of a musical genre to the audio file being tagged. In category tags block 906 musical genre may be assigned using drop down menu 908. Available genre selections in drop down menu 908 may include: Rock/Blues, Electronic/Dance, Jazz, Urban, World/Ethnic, Cinematic/New Age, Orchestral, Country/Folk, Experimental, etc. Here again, a user may use controls 410 to playback the audio file in order to facilitate the proper genre selection.

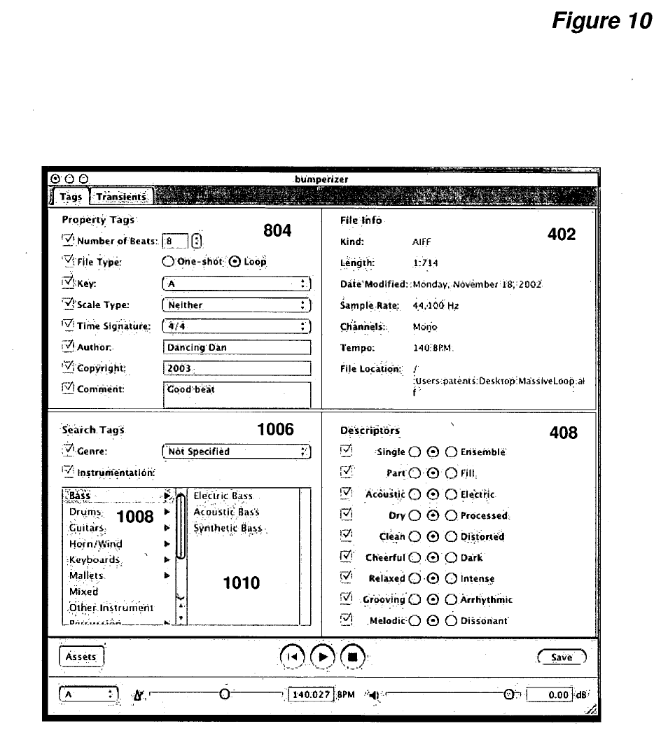

FIG. 10 illustrates how a user might define a set of these musically distinct classifications by assigning an audio file to a set of instrumentation category tags. Category tag block 1006 includes instrumentation windows 1008 and 1010. In window 1008, the type of instrument is presented and in window 1010, the sub-category of the instrument is presented. For instance, if the type of instrument is bass, then the sub-categories may include electric bass, acoustic bass, and synthetic bass.

The kind of instruments in block 1008 may in addition to bass, include: drums, guitars, horn/wind, keyboards, mallets, mixed, percussion, sound effects, strings, texture/vocals, and other instruments. For each category of instrument, there may be sub-categories listed in block 1010.

Sub-categories of drums available for selection in block 1010 may include, e.g., drum kit, electronic beats, kick, tom, snare, cymbal and hi-hat. Sub-categories for guitars may include, e.g., electric guitar, acoustic guitar, banjo, mandolin, slide guitar, and pedal steel guitar. Sub-categories for horn/wind may include: saxophone, trumpet, flute, trombone, clarinet, French horn, tuba, oboe, harmonica, recorder, pan flute, bagpipe, and bassoon. Sub-categories for keyboards may include: piano, electric piano, organ, clarinet, accordion and synthesizer. Sub-categories for mallets may include: steel drum, vibraphone, marimba, xylophone, kalimba, bell, and timpani. Sub-categories of percussion may include: gong, shaker, tambourine, conga, bongo, cowbell, clave, vinyl/scratch, chime, and rattler. Sub-categories of strings may include: violin, viola, cello, harp, koto, and sitar. And finally, sub-categories of texture/vocals may include: male, female, choir, etc. Using interface blocks 1008 and 1010, the user or creator may assign the appropriate category and sub-category of instrumentation, from the various choices, to the audio file.

Descriptors

The final steps in tagging involve assigning descriptors to the audio file. Descriptors could, for instance, convey the mood or emotion the sound in the audio file tends to trigger.

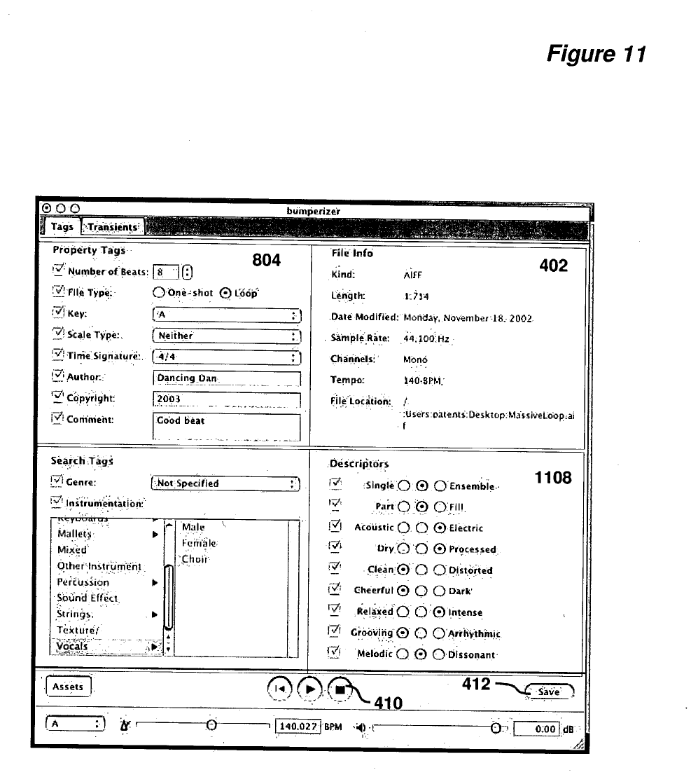

FIG. 11 is an illustration of assignment and selection of descriptors. Multiple descriptors may be assigned to the same audio file. For instance, the user may specify whether the audio file is by a single soloist or an ensemble of soloists; part or fill; acoustic or electric; dry or processed; clear or distorted; cheerful or dark; relaxed or intense; grooving or arrhythmic; and melodic or dissonant. In the illustration of FIG. 11, the audio file massiveloop.aif is assigned descriptors in block 1108 corresponding to: electric, processed, clean, cheerful, intense, and grooving.

After the assignment of all the tags and descriptors, the file is then saved using button 412. Again, as discussed previously, one method of saving is to append the tags and descriptors data to the end of the audio file. The appended data could take any desired format, e.g., XML.

Indexing Interface

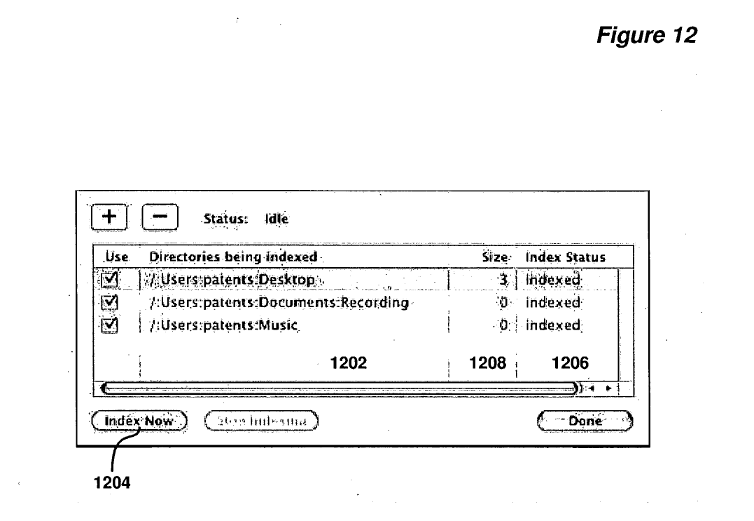

In the first phase the indexer goes through the directory containing the files to be indexed and recursively traverses the path. The path to be indexed may come for example, from the user using the user interface of FIG. 12.

FIG. 12 is an illustration of a user interface for indexing audio files. The user selects the directory path to be indexed by highlighting desired directories in window 1202, labeled “Directories Being Indexed” and then selecting the “Index Now” button 1204. In window 1206, the user is provided information as to the status of each directory. But if it had been indexed, then it may contain information such as “Indexed”.

In block 1208, the indexer presents the number of audio files in the directory. In the illustration, the audio file directory “/:Users:patents:Desktop” contains three audio file files which were indexed.

Search Interface

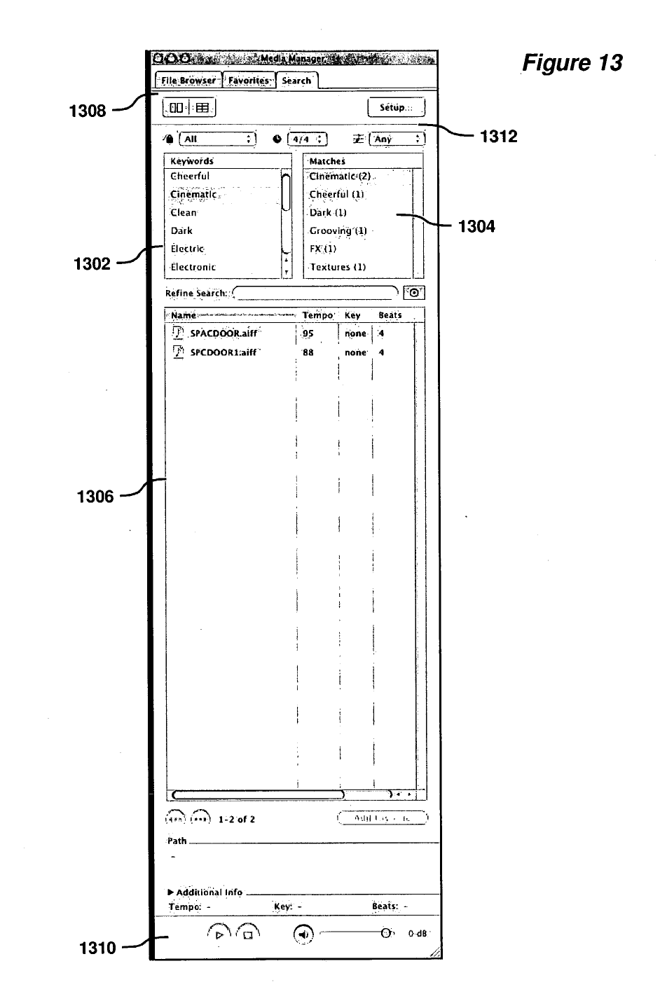

FIG. 13 is an illustration of a search engine interface in accordance with an embodiment of the present invention. The indexing phase discussed above parses the set of audio files in each directory path to obtain tag information, which is then distilled down to a set of key words. The indexer builds a large data structure for each directory and saves it. All the data structures generated are subsequently processed through the translation process discussed above and the limited set of keywords found is used to populate menu block 1302. Note that keywords not found will not appear in menu block 1302. Therefore, block 1302 may not contain the entire set of search engine keywords, just the limited set of keywords exposed as part of the indexing process. Thus, the indexer does not list words for which there are no matches.

This is unlike conventional search engines, which allow users to submit any set of keywords, even those that return an overly broad set of matches or perhaps nothing at all. Thus, in embodiments of the present invention, certain keywords are exposed to the user. Prior art search engines do not expose aspects of the index and thus users must type in a query and arrange words such as by placing them within quotes or try to guess how the search is indexed in attempts to get a high quality match.

Embodiments of the invention are unlike prior art search engines in that the user is only provided keywords that are already associated with audio files. Thus, the user may select the appropriate keyword to refine the search results. For instance, assuming a keyword search that produces forty-seven organs, forty-six of which are in the general category, and one of which is an “intense organ”. A user looking for more than an organ need not wonder whether there is an “intense organ” for example because the user interface will clearly show that there is an intense organ. If the user desires the intense organ, they can simply click on it and the file name will appear on block 1306. The indexer provides the user information about all the tagged files so that there is not guessing while searching for a desired audio file.

In the illustration of FIG. 13, the keywords found in the indexed files include “Cheerful”, “Cinematic”, “Clean”, “Dark”, “Electric”, “and “Electronic”. The matches are shown in block 1304 as follows: two files match the “Cinematic” keyword, one file is “Cheerful”, one file is “Dark”, one file is “Grooving”, one file is “FX”, and one file is “Textured”. Thus if the user desires “Cinematic” genre, the user selects the keyword “Cinematic” from menu block 1302. Menu block 1304 may be used to refine the search and thus narrow the match results. In block 1306, the two “Cinematic” files are presented to the user. The user may then play the audio file using control buttons 1310. Thus, the user need only listen to those audio files that within some limit of what the project requires.

A user wants to preview audio files to determine appropriate ones for the particular project. The user may not want to preview several hundred piano sounds, for example. Thus an embodiment of the present invention provides a tone-limiting feature. The tone-limiting feature uses the project key, e.g., A, and only return audio files which are within a desired number of semitones, e.g., two semitones of the project key. For instance, two semitones from A is A sharp (A♯) and B, and G sharp (G♯) and G. This capability further narrows the search from the search engine. Thus, if a normal search will produce over a thousand horns, for example. Activating the tone-limiting feature provides the user only those audio files that are close to the project key so the user does not have preview audio files that are so far off to fit in the project. Thus, the tone-limiting feature further reduces the set of audio files to give a tight search result.

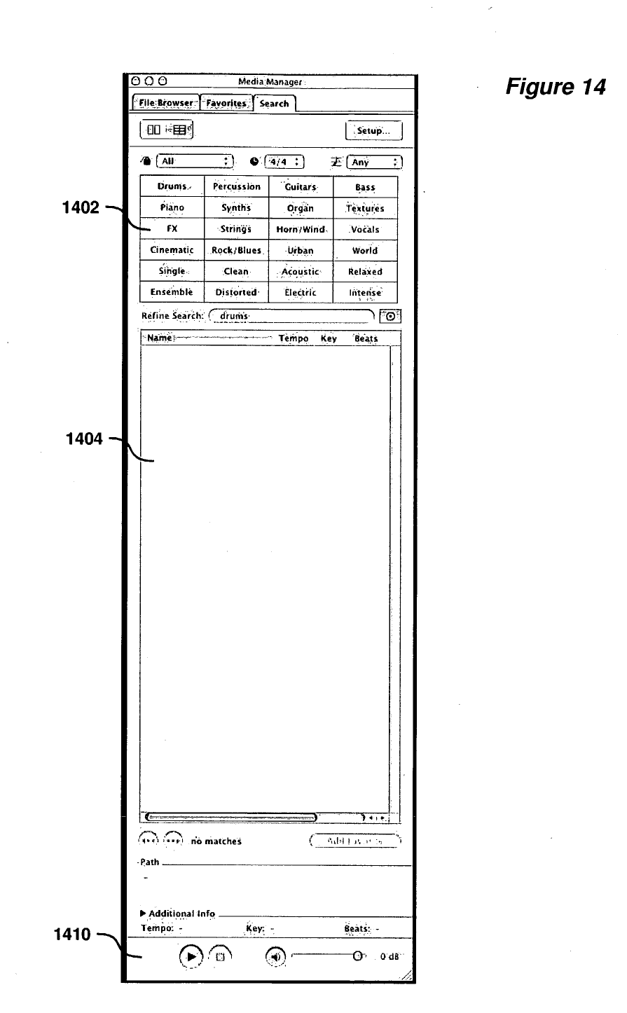

Another embodiment of the present invention provides the user preprogrammed selectable buttons. The button view is shown in FIG. 14. Unlike the column view of FIG. 13, which allows a user to do complex searches by organizing every single keyword in a column for the user, the button view provides a very limited set of keywords. For example, the button labels in block 1402 include: Drums, Percussion, Guitars, Bass, Piano, Synths (i.e., synthesizer), Organ, Textures, FX, strings, Horn/Wind, Vocals, Cinematic, Rock/Blues, Urban, World, Single, Clean, Acoustic, Relaxed, Ensemble, Distorted, Electric, and Intense.

This capability allows the simple user who just desires drums to click on “Drums” and all the drums will instantly appear in block 1404. The user does not have to scroll through a list of keywords in this mode.

Other embodiments of the invention provides users with the ability to perform an “and” and an “or” search. An “and” search provides an intersection of the keywords. The “or” search provides results to match any the selected keywords.

Refine Search

Once an initial search result is obtained using graphical widgets 1302, 1034 or 1402, the user may elect to additionally narrow the search using the “Refine Search” command. The user may enter any set of keywords into the “Refine Search” box 1450 (even keywords that are not from the constrained set of keywords depicted on the graphical user interface). The system may then evaluate the search results using more traditional search techniques (e.g., filename, directory path information, etc . . . ) based on the information provided in box 1450. Thus, the refine command provides a way to further limit the set of search results based on user-defined keywords.

Search and Data Presentation Methodologies

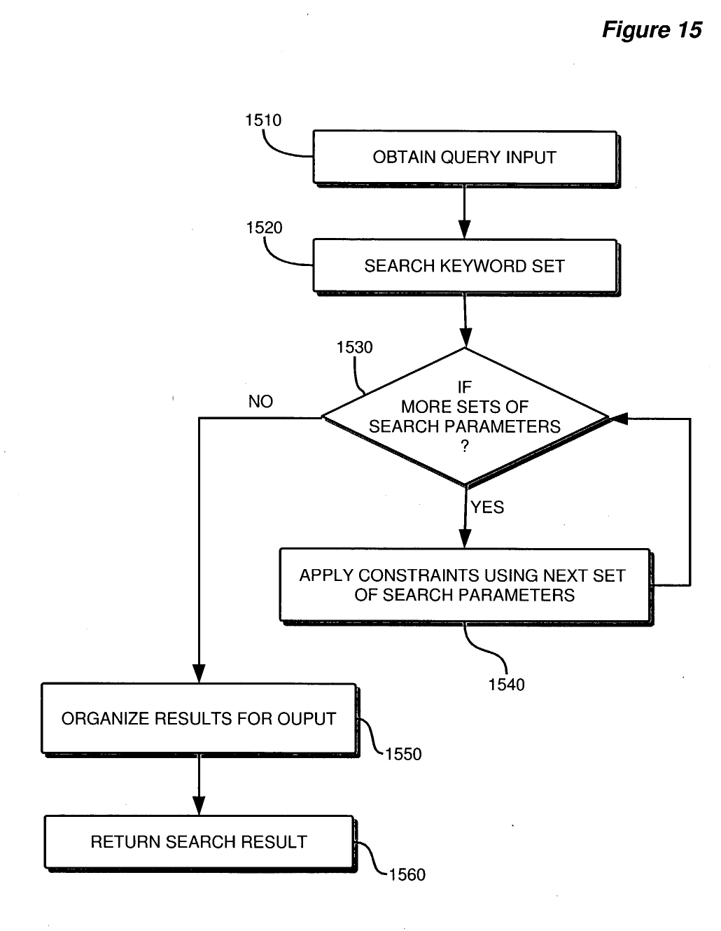

FIG. 15 is a flowchart that illustrates the overall steps involved in the process of searching an index to find files that match one or more sets of search criteria in accordance with embodiments of the invention. At step 1510, the method obtains a set of search parameters. As described above, a system embodying the invention implements a plurality of graphical user widgets that enable a user to easily select parameters to constrain a search for files.

Furthermore, the system allows the user to refine a search by entering one or more keywords/key phrases. Along with the keywords, the user may enter a sequence and logical (or conditional) statements in the form of “AND” and “OR” statements that allow the system to perform a more intelligent search.

The system may organize search parameters into sets of kin parameters. For example, the user may select a range of values based on the time information (e.g., beat rate) for searching music tracks in data files. The system may parse the search values to establish a defined range of a maximum and minimum time values, for example.

At step 1520, the system searches the keyword set. The detailed steps involved in keyword searches are described below. At step 1530, the system checks whether one or more sets of searching parameters are available to conduct a refinement of the search. If the system determines that a set of search parameters is to be applied to the intermediate search result, then the system applies the constraints in the search parameter set to the search result at step 1540. For example, the system may determine that a search query comprises search parameters for music loops that have time signature within a given range. In this case, the system determines the upper limit and the lower limit of the search range and tests each item in the search result against the range's limits. The system may iterate the search to cover every search option included in the search query. For example, the system may iterate the search to constrain the search results based on the project key.

When the system finishes applying the search constraints to the search results, it applies a method for organizing the result at step 1550. Organizing the result for output may involve classifying the data in accordance with one or more criteria (e.g. instrument type, instrument sub-type, music genre etc.). At step 1560, the system returns the data for display on the graphical user interface.

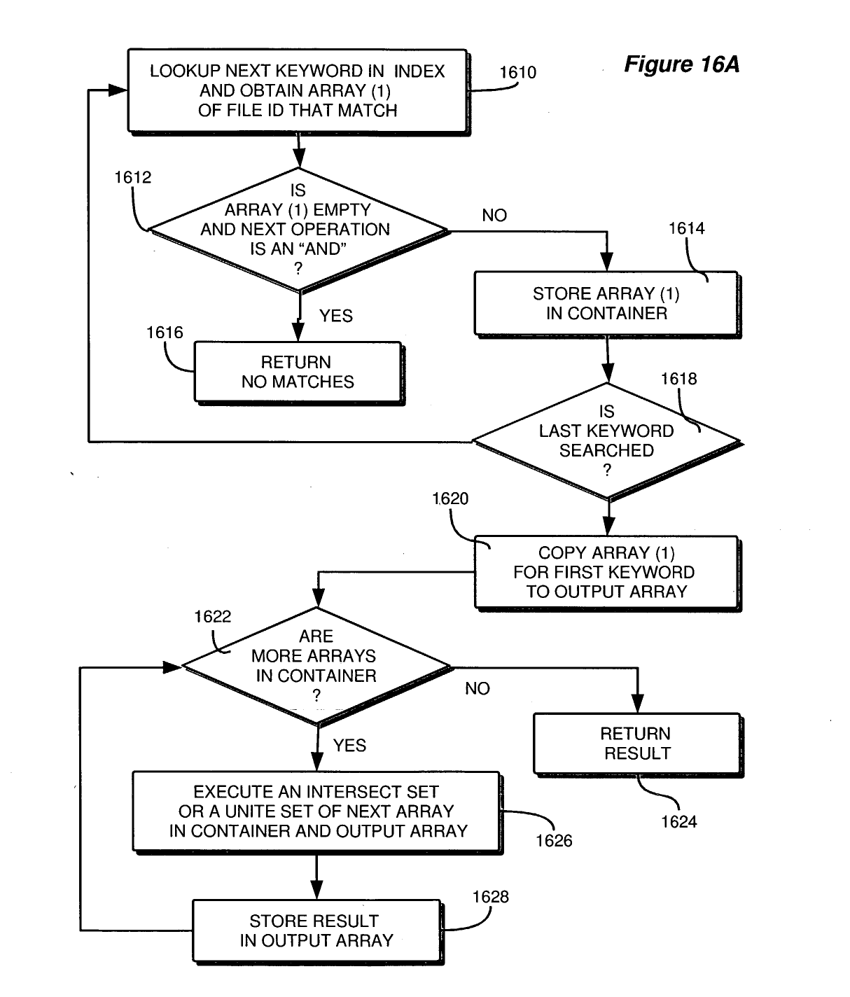

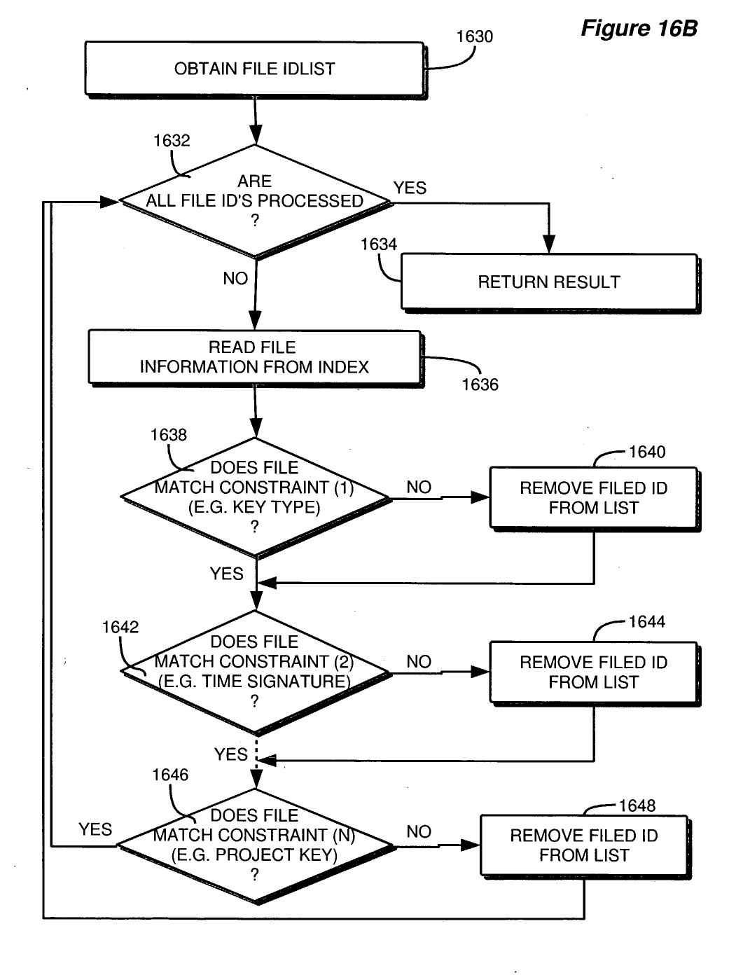

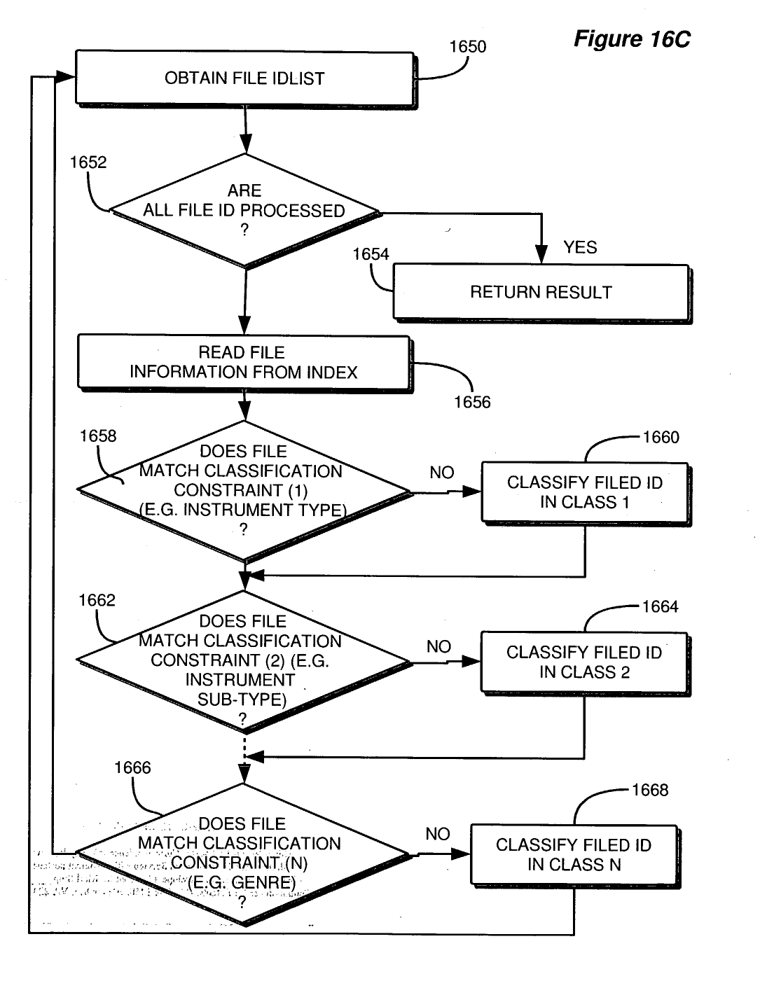

FIG. 16A is a flowchart illustrating a process for searching the index using keywords. A system embodying the invention builds a query based on user input (as described at step 1510). This query may comprise keywords and/or key phrases, directly entered by the user in addition to keywords graphically selected by clicking on-screen widgets. The system utilizes both keywords and graphically selected items to build a set of constraints to be applied during the search process. At step 1610, the system iteratively uses each keyword, in a set of keywords, to search the index that associates each data file with a corresponding list of keywords. When the system encounters a search keyword in a list, the system selects the file identifier associated with the list. The result of each keyword match may be an array of file identifiers. At step 1612, the system performs a logical statement. When the search is concerned with only one keyword and the result is empty or in the case of multiple keyword search, the result is empty and an “AND” logical operation follows the keyword, the system aborts the search and returns a “no match” result at step 1616. When the search returns with an array of one or more file identifiers, the system stores the array in a container at step 1614.

At step 1618, the system checks whether all keywords were processed. After the system checks the keywords against the index, it proceeds to copy the array associated with the first keyword (that returned a result) in the container into an output container at step 1620. The system checks every array in the container at step 1822. If more arrays are available for processing in the container, the system iteratively determines the logical operation that is to be applied between the corresponding keyword and the rest of the keywords at step 1626. The system may determine that a keyword is associated with an “AND” operation with the previous search keywords in a keyword set. In the latter case, the system performs an intersect combining the array corresponding to the keyword in question and the array in the output container. The result is an array of file identifiers that match the conditions set by the keywords and the conditionals entered by the user. If the system determines that the keyword in question is associated with an “OR” operation with previous keywords, it performs an union operation between the array associated with the keyword in question and the array stored in the output container. After executing the logical operations, the system copies the result to the output container and returns the result at step 1628.

FIG. 16B is a flowchart that illustrates the application of further search constraints on a set of keyword search results. At step 1630, the system embodying the invention obtains a list of file identifiers associated with the existing search results. At step 1632, the system iteratively checks whether each file associated with an identifier in the list has been processed. When all files have been processed, the system returns a result at step 1634. Otherwise, for each file associated with an identifier in the list, the system reads the file information from the index, at step 1636, then iteratively checks (e.g. at step 1638) whether the file should match a certain constraint condition. If the index information fails the match test, the system removes the file identifier from the list, at step 1640, and eventually proceeds to further constrain the result. For example, the match test of step 1638 may only select those files that match a key of a given type in the case of music data. The system may execute several constraining matches such as time signature, as in step 1642, and project key as in step 1646, and correspondingly remove the file identifiers, as in step 1644 and step 1648, respectively, for files that do not match the constraining conditions.

FIG. 16C is a flowchart that illustrates steps involved in organizing the output of search result in accordance with embodiments of the invention. The system embodying the invention possesses the ability to classify, sort and arrange data in a manner most compatible with the human way of viewing music data. For example, when classifying music humans often consider the music genre. Such a consideration is based on subjective criteria that is not part of most presentation interfaces. At step 1650, the system obtains a list of file identifiers such as one that result from a search constraining application described in FIG. 16B. The system iteratively checks each file identifier at step 1652. When all files in the list have been processed the system returns the result at step 1654. Otherwise, for each file associated with a file identifier in the list, the system loads the information from the index, at step 1656, then proceeds to apply any number of matches to classify, sort and/or arrange file identifiers in any fashion compatible with the viewing conditions of the system embodying the invention. At step 1658, the system checks whether a file being processed matches a condition for classification. For example, if the search is concerned with instrument type, the system tries to match file information with instrument type. If the file matches any of the categories, the system classifies the file in the proper category (e.g. Instrument type) at step 1660. The system proceeds to consecutively match any other classification criterion as in steps 1662 and 1666, and accordingly apply the classification functions to the file as in step 1664 and step 1668, respectively.

Thus, a method and apparatus for implementing a domain specific search has been described. Particular embodiments described herein are illustrative only and should not limit the present invention thereby. The invention is defined by the claims and their full scope of equivalents.

What is claimed is:

1. A method for locating sound files comprising:
specifying a directory having a plurality of sound files;
parsing each of said plurality of sound files to extract tag information;
generating one or more words and word pairs from said tag information;
generating one or more keywords from said one or more words and word pairs, wherein said keywords are utilized to build an index associating each one of said plurality of sound files with said keywords; and
providing said one or more keywords to a user for use as query in searching for a desired sound file.

2. The method of claim 1, wherein said directory is a network path.

3. The method of claim 1, wherein said directory is the World-Wide-Web.

4. The method of claim 1, wherein said directory is a computer storage media.

5. The method of claim 1, wherein said each of said plurality of sound files has tag information appended to an audio content.

6. The method of claim 1, wherein said each of said plurality of sound files has an associated tag information.

7. The method of claim 1, wherein said tag information comprises property tags.

8. The method of claim 1, wherein said tag information comprises search tags.

9. The method of claim 1, wherein said tag information comprises descriptors.

10. The method of claim 1, wherein said searching for a desired sound file produces a second plurality of sound files.

11. The method of claim 10, wherein each of said second plurality of sound files is within a predefined number of semitones of said project.

12. The method of claim 1, wherein said generating one or more keywords comprises running said one or more words and word pairs through a translation process.

13. The method of claim 12, wherein said translation process comprises equating said one or more words and word pairs with at least one keyword.

14. The method of claim 13, wherein said equating comprises a translation table lookup.

15. An apparatus for locating sound files on a computer system comprising:
a first graphical user interface on a computer system for specifying a directory having a plurality of sound files;
an indexer on said computer system parsing each of said plurality of sound files to extract tag information, said indexer generating one or more words and word pairs from said tag information;
a translator associated with said indexer for generating one or more keywords from said one or more words and word pairs; and
said indexer providing said one or more keywords at a second graphical user interface for use as query in searching for a desired sound file for a project.

16. The apparatus of claim 15, wherein said directory is a network path.

17. The apparatus of claim 15, wherein said directory is the World-Wide-Web.

18. The apparatus of claim 15, wherein said directory is a computer storage media.

19. The apparatus of claim 15, wherein said each of said plurality of sound files has tag information appended to an audio content.

20. The apparatus of claim 15, wherein said each of said plurality of sound files has an associated tag information.

21. The apparatus of claim 15, wherein said tag information comprises property tags.

22. The apparatus of claim 15, wherein said tag information comprises search tags.

23. The apparatus of claim 15, wherein said tag information comprises descriptors.

24. The apparatus of claim 15, wherein said searching for a desired sound file produces a second plurality of sound files.

25. The apparatus of claim 24, wherein each of said second plurality of sound files is within a predefined number of semitones of said project.

26. The apparatus of claim 15, wherein said generating one or more keywords comprises said translator running said one or more words and word pairs through a translation process.

27. The apparatus of claim 26, wherein said translation process comprises equating said one or more words and word pairs with at least one keyword.

28. The apparatus of claim 27, wherein said equating comprises a translation table lookup.
